(19) United States
(12) Patent Application Publication
(10) Pub. No.: US 2016/0054864 A1
(43) Pub. Date: Feb. 25, 2016

(54) DISPLAY APPARATUS AND CONTROLLING METHOD THEREOF

(71) Applicant: SAMSUNG ELECTRONICS CO., LTD., Suwon-si (KR)

(72) Inventors: Kyeong-a HAN, Suwon-si (KR); Yong-hwan KWON, Seongnam-si (KR); Ji-woo SUH, Seoul (KR); Ji-youn HAN, Suwon-si (KR)

(73) Assignee: SAMSUNG ELECTRONICS CO., LTD., Suwon-si (KR)

(21) Appl. No.: 14/626,247

(22) Filed: Feb. 19, 2015

(30) Foreign Application Priority Data
Aug. 22, 2014 (KR) 10-2014-0109747

(51) Int. Cl. G06F 3/0482; G06F 17/30; G06F 3/0485

(52) U.S. Cl. CPC G06F 3/0482; G06F 3/0485; G06F 17/30876

(57) ABSTRACT

A display apparatus and method are provided. The display apparatus includes a display configured to display a user interface (UI) screen, a storage configured to divide and store information about a user preference content and a user preference function according to a user preference type, and a controller configured to, in response to a predetermined event, control the display to display a UI including a graphic user interface (GUI) item indicating the user preference content and a GUI item indicating the user preference function, respectively, based on the information stored in the storage.

### CROSS-REFERENCE TO RELATED APPLICATION(S)

This application claims priority from Korean Patent Application No. 10-2014-0109747, filed on Aug. 22, 2014, in the Korean Intellectual Property Office, the disclosure of which is incorporated herein by reference in its entirety.

### BACKGROUND

1. Field

Apparatuses and methods consistent with exemplary embodiments relate to a display apparatus and a controlling method thereof, and more particularly, a display apparatus which provides a user interface (UI) screen and a method for controlling the display apparatus.

2. Description of Related Art

Due to the recent development of the content providing industry and consumer electronics, various kinds of content are being provided through various electronic technologies. For example, an electronic apparatus that is able to combine an application function of a smart phone with that of television (TV) content and the like, has been recently developed.

TV content may include a drama, a documentary, and the like, produced by a broadcasting station, produced by a foreign broadcasting station, and the like. Also an application may include an application that provides a social network service, an application with various functions such as an application for providing information, and the like.

With the development of electronic technology, an apparatus with various standards with respect to hardware has been developed. Apparatuses supporting a High Definition Multimedia Interface (HDMI) standard and a mobile high-definition link (MHL) standard are representative examples. Transmission of content between various apparatuses has become easier using these standards.

As described above, a user may contact various contents and electronic apparatuses, but it may be difficult to select a content that the user prefers or an apparatus that the user wants to use.

FIG. 1A is a drawing illustrating a related art user interface (UI) screen which provides a content list.

In FIG. 1A, drama contents are only illustrated. A menu regarding a drama ‘ABC’ among dramas is provided according to an episode. Here, a user can select an episode which is arranged in an order of time. However, if there are a lot of episodes, it may be difficult for the user to find and select a previous episode that a user desires to view.

FIG. 1A illustrates a drama menu, and only a drama “ABC” among dramas, but it should be appreciated that a broadcasting company and another drama may be included as a menu, and in this case, the user may be required to make many manipulations to watch a content that the user desires. In other words, if content is arranged in an order of time, it may be difficult for the user to select a content that the user wants from contents which are provided variously.

FIG. 1B is a drawing illustrating a related art UI screen which provides a favorite list.

Referring to FIG. 1B, a user can add specific content to a favorite list and select preferred content. As an example, content which can be added to a favorite list is not only a drama and a movie, but also a specific channel. However, it is difficult for a specific application or another electronic apparatus which is connected to a display apparatus to be added to the favorite list. Also, even if it is added to the favorite list, it is limited to an identical type, and thus, it is inconvenient for the user.

Accordingly, a technology for effectively using various contents and functions provided by the display apparatus is desired.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments provide a display apparatus which displays various content and functions on a single UI screen without a distinction of a type and a display method thereof.

According to an aspect of an exemplary embodiment, there is provided a display apparatus including a display configured to display a user interface (UI) screen, a storage configured to divide and store information about a user preference content and a user preference function according to a user preference type, and a controller configured to, in response to a predetermined event, control the display to display a UI including a graphic user interface (GUI) item indicating a user preference content and a GUI item indicating a user preference function, respectively, based on information stored in the storage.

The user preference content and the user preference function may be divided into a first preference type which is determined based on a user interaction and a second preference type which is determined based on a frequency of use.

The controller may provide a GUI item corresponding to the first preference type prior to a GUI item corresponding to the second preference type, in order.

The controller may be configured to, in response to there being a plurality of GUI items corresponding to the second preference type, provide the plurality of GUI items in order based on a use time of the user preference content and a frequency of use of the user preference function.

The user preference content may include a preference application and a preference channel, and the controller may group a GUI item corresponding to the preference application, the preference channel, and the preference function according to a type, and alternatively display and provide the grouped GUI items.

The controller may provide the GUI item in a shape that is enumerated in a row on a partial area of a screen according to a predetermined first event, and categorize and provide the GUI item on an entire area of the screen according to a predetermined second event.

The controller may control the display to display the GUI item which indicates the user preference content in a shape of a thumbnail.

The user preference function may include an external input selection function.

The display apparatus may further include a user interface configured to receive a user instruction, and the controller may convert a second preference type item selected on the UI screen to the first preference type, in response to a predetermined user instruction being received.

The controller may display identification information which indicates the first preference type on a GUI item indicating a user preference content and a user preference function of the first preference type.

According to an aspect of another exemplary embodiment, there is provided a method of controlling a display apparatus including determining whether a predetermined event has occurred, and, in response to determining the predetermined event has occurred, displaying a UI screen which divides and provides a GUI item indicating a user preference content and a GUI item indicating a user preference function, respectively, according to a user preference type.

The user preference content and the user preference function may be divided into a first preference type determined based on a user interaction and a second preference type determined based on the second preference type.

The displaying the UI screen may include providing a GUI item corresponding to the first preference type prior to a GUI item corresponding to the second preference type, in order.

The displaying the UI screen may include, in response to there being a plurality of GUI items corresponding to the second preference type, providing the plurality of GUI items in order based on a use time of the user preference content and a frequency of use of the user preference function.

The user preference content may include a preference application and a preference channel, and the displaying the UI screen may include grouping a GUI item corresponding to the preference application, the preference channel, and the preference function according to a preference type, and alternatively displaying and providing the grouped GUI items.

The displaying the UI screen may include providing the GUI item in a shape that is enumerated in a row on a partial area of a screen according to a predetermined first event, and categorizing and providing the GUI item on an entire area of a screen according to a predetermined second event.

The displaying the UI screen may include displaying the GUI item which indicates the user preference content in a shape of a thumbnail.

The user preference function may include an external input selection function.

The method may further include receiving a user instruction, and the displaying the UI screen may include converting a second preference type item selected on the UI screen to the first preference type, in response to receiving a predetermined user instruction.

The displaying the UI may include displaying identification information which indicates the first preference type on a GUI item indicating a user preference content and a user preference function of the first preference type.

According to one or more exemplary embodiments, the display apparatus may provide various contents and functions through a UI screen more efficiently.

### BRIEF DESCRIPTION OF THE DRAWINGS

The above and/or other aspects will be more apparent by describing certain exemplary embodiments with reference to the accompanying drawings, in which:

FIGS. 1A and 1B are views illustrating a UI screen according to a related art;

FIGS. 2A and 2B are block diagrams illustrating a display apparatus according to various exemplary embodiments;

FIGS. 3A and 3B are views illustrating a UI screen which provides a GUI item according to various exemplary embodiments;

FIGS. 4A to 4C are views illustrating a UI screen which provides a GUI item according to other various exemplary embodiments;

FIGS. 5A to 5D are views illustrating a favorite GUI item according to various exemplary embodiments;

FIGS. 6A and 6B are views illustrating information stored in a storage according to various exemplary embodiments;

FIG. 7 is a flowchart illustrating a method of displaying a UI screen according to an exemplary embodiment;

FIG. 8 is a flowchart illustrating a method of displaying a UI screen according to another exemplary embodiment; and

FIG. 9 is a flowchart illustrating a method of storing data in a storage according to an exemplary embodiment.

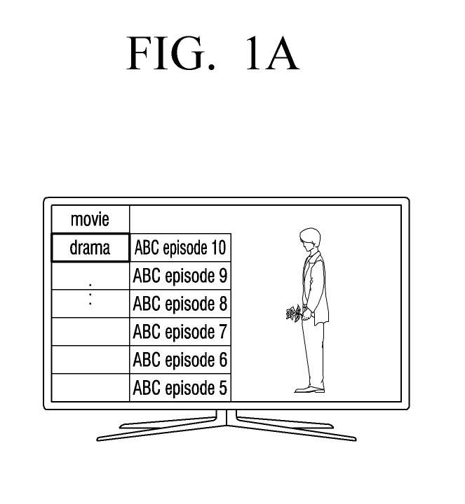

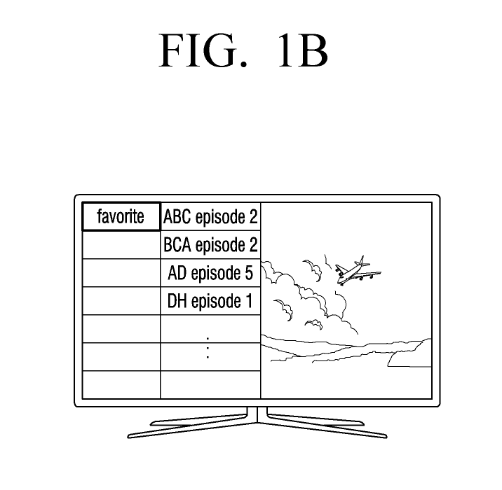

### DETAILED DESCRIPTION

Hereinafter, exemplary embodiments are described in greater detail herein with reference to the accompanying drawings. Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

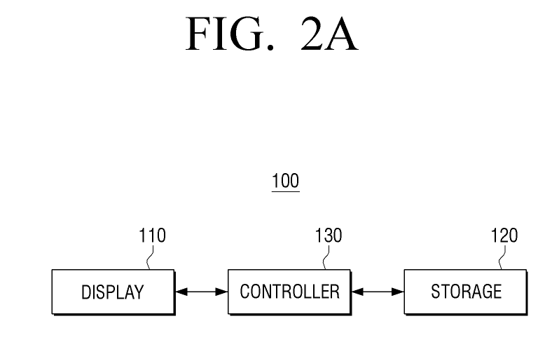

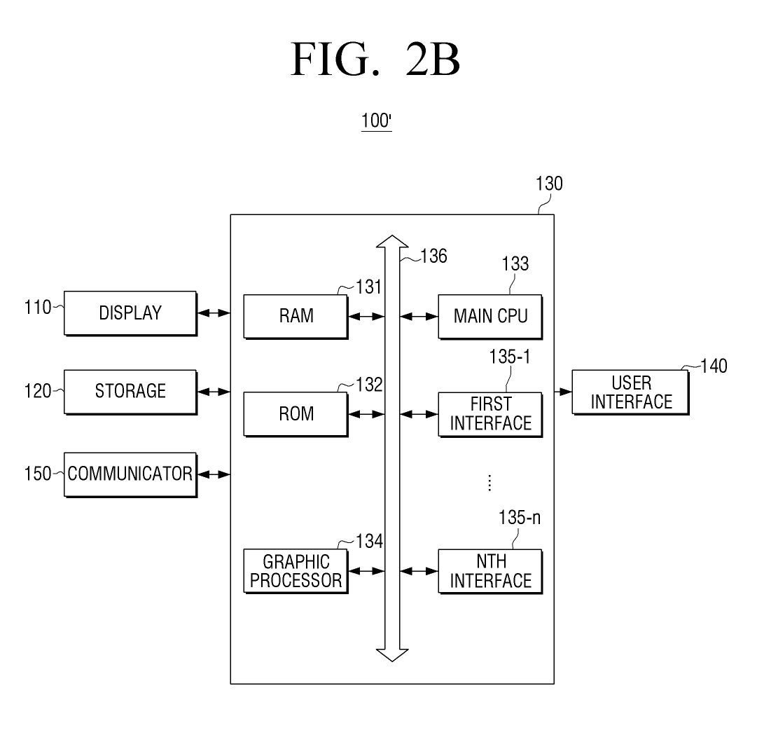

FIGS. 2A and 2B are block diagrams illustrating a display apparatus 100 according to various exemplary embodiments. In FIG. 2A, the display apparatus 100 includes a display 110, a storage, and a controller 130. For example, the display apparatus 100 may be a television, a mobile phone, a game console, a set-top box, a tablet, a computer, a notebook, and the like.

The display apparatus 100 may display content provided by a broadcast service or execute an application. As another example, the display apparatus 100 may receive and display content from an external electronic apparatus. If an application is executed, data used to execute the application may be received using an internet network connected with the display apparatus 100.

A socket may function as a digital video interactive (DVI), D-SUB, HDMI, USB, MHL, and the like, and may be provided on the back of the display apparatus 100. If another apparatus is not connected with each of the sockets, a function provided from the front of the display apparatus may not be executed if the function is not selected.

The display 110 displays various UI screens. For example, the UI screen may include content provided by a broadcast company or service provider such as a TV and/or radio, but this is just one of many possible examples. As another example, UI screen may include not a television, but a broadcasting company channel itself as a content.

The display 110 may display a UI screen which may execute a social network application such as Skype®, Facebook®, and the like. However, this is just one of many possible examples, and the display 110 may display a UI screen which is able to execute various applications such as a news application, a life information application, and the like.

The display 110 may provide a UI screen that includes a function of connecting with another apparatus such as an HDMI, a DVI, and the like. Whether to support a standard to connect with another apparatus may be different according to the specifications of an electronic apparatus, and the electronic apparatus may provide various functions when connected.

If content is displayed or content is received and displayed from an external electronic apparatus, the display 110 may display a UI screen illustrating a user preference content and a user preference function. The UI screen may be displayed on a portion only of the display 110 while content is displayed, or may be displayed on an entire area of the screen including details.

The display 110 may include, for example, a liquid crystal display panel (LCD), an organic light emitting diode (OLED) display panel, and the like, but is not limited thereto. Also, the display may be a flexible display, a transparent display, and the like, according to a case.

The storage 120 may store various data for driving the display apparatus such as, for example, an operating system (O/S) software module, various channel information, various application information, connection information with various external apparatus, and the like.

The storage 120 may divide and store information about a user preference content and a user preference function according to a user preference type, and the storage 120 may store at least one between a UI screen which provides a GUI item provided from the display in order, and information about a user preference content and a user preference function divided according to a user preference type.

In this example, the controller 130 may display a UI screen which provides a GUI item in order based on the information stored in the storage unit, and digitalize a preference according to a use of the display apparatus 100 by a user and store the digitalized preference in the storage 120.

The controller 130 may control the overall operation of the display apparatus 100. For example, the controller 130 may control the display 100 to display a UI screen including a GUI item indicating a user preference content and a user preference function, respectively, based on the information stored in the storage 120 according to a predetermined event. Herein, the function may include an external input selection function.

The user preference content and the user preference function may be divided into a first preference type determined based on a user interaction and a second preference type determined based on a frequency of use. The user interaction may be an operation of directly selecting a specific content or a function of the user. For example, the user interaction may be the user selecting content or a function that the user desires to select as a favorite of the user. The frequency of use may be a use time or a number of uses.

The controller 130 may provide a GUI item corresponding to the first preference type prior to a GUI item corresponding to the second preference type, but this is merely one example, and one or more GUI items may be provided on the contrary to this. A user may change a setting. Also, to divide the first preference type and the second preference type, a mark displaying the first preference type on a portion of the GUI item which indicates a user preference content and a user preference function of the first preference type may be additionally displayed.

If there are a plurality of GUI items corresponding to the first preference type, the controller 130 may provide a GUI item corresponding to the first preference type in the order of a user's interactions. As another example, if there are a plurality of GUI items corresponding to the second preference type, a GUI item may be provided in order based on a use time of a user preference content and a frequency of use of a user preference function.

A user preference content may include a preference application and a preference channel. The controller 130 may group a GUI item corresponding to a preference application, a preference channel and a preference function according to a type, and may display alternatively and provide the GUI item. An example of a UI screen which provides the above-described GUI item is explained below.

The controller 130 may display a UI screen which provides a GUI item in order on a portion of the display 110 while content is displayed, but this is just one example, and a GUI item may be categorized and provided on an entire area of the screen. For example, the controller may display the UI screen including the GUI items arranged in a scrollable fashion such that they are arranged on only part of the screen, and not covering an entire area of the screen. As another example, the controller may display the UI screen over the entire area of the screen.

As a non-limiting example, a GUI item may be provided in a shape that is enumerated in a row direction on a portion of a screen according to the predetermined first event, and the GUI items may be categorized and provided on an entire area of the screen according to the predetermined second event.

For example, the first event may include turning on the display apparatus 100 using a power button 510, or turning on the display apparatus 100 with a remote controller. The second event may include pushing a menu entry button 520 of the remote controller on the UI screen according to the first event, and the third event may include pushing the menu entry button 520 of the remote controller on the UI screen according to the second event.

Herein, the controller 130 may display a GUI item which indicates a user preference content in a shape of a thumbnail, but this is one of many examples, and the GUI item may be displayed as another shape such as in a shape of an icon.

The display apparatus 100 may further include a user interface (not illustrated) which receives a user instruction, and the controller 130 may change a preference type from the second preference type item which is selected according to a predetermined user instruction on the UI screen, to the first preference type.

The controller 130 may display identification information indicating the first preference type on a GUI item which indicates a user preference content and a user preference function of the first preference type.

FIG. 2B is a block diagram illustrating a display apparatus (100) according to another exemplary embodiment. According to FIG. 2B, the display apparatus 100 includes the display 110, the storage 120, the controller 130, a user interface 140, and a communicator 150. Among elements illustrated in FIG. 2B, a redundant explanation regarding like elements illustrated in FIG. 2A is omitted.

The controller 130 may control an overall operation of the display apparatus 100 using various programs stored in the storage 120. For example, the controller 130 may include a random-access memory (RAM) 131, a read-only memory (ROM) 132, a main central processing unit (CPU) 133, a graphic processor 134, first to nth interfaces 135-1˜135-n, and a bus 136. The RAM 313, the ROM 132, the main CPU 133, the graphic processor 134, the first interface to the nth interface 135-1˜135-n, and the like, are connected each other through the bus 136.

The first interface to the nth interface 135-1˜135-n may be connected with various elements described above. For example, one or more of the interfaces may be a network interface that connects to an external apparatus through a network.

The main CPU 133 accesses the storage unit 120, may perform booting using an O/S stored in the storage. The storage 120 performs various operations using various applications, contents, data, and the like, stored in the storage 120.

An instruction set for a system boot may be stored in the ROM 132. If a turn-on instruction is input and a power is provided, the main CPU 133 may copy an O/S stored in the storage 120, into the RAM 131, according to an instruction word stored in the ROM 132, execute the O/S and boot up a system. If the boot is completed, the main CPU 133 may copy various application programs stored in the storage 120, to the RAM 131, execute the application program copied to the RAM 131, and perform various operations.

The graphic processor 134 generates a screen including various objects such as, for example, an icon, an image, a text, and the like, using a calculating unit (not illustrated) and a rendering unit (not illustrated). The calculating unit calculates an attribute value such as a coordinate value, a shape, a size, a color and the like, where each object is to be displayed according to a layout of the screen, based on a received control instruction. The rendering unit generates a screen of various layouts including an object based on the attribute value calculated at the calculating unit. A screen generated by the rendering unit is displayed on a display area of the display 110.

Also, the controller 130 may be operated as described above by a program stored in the storage 120.

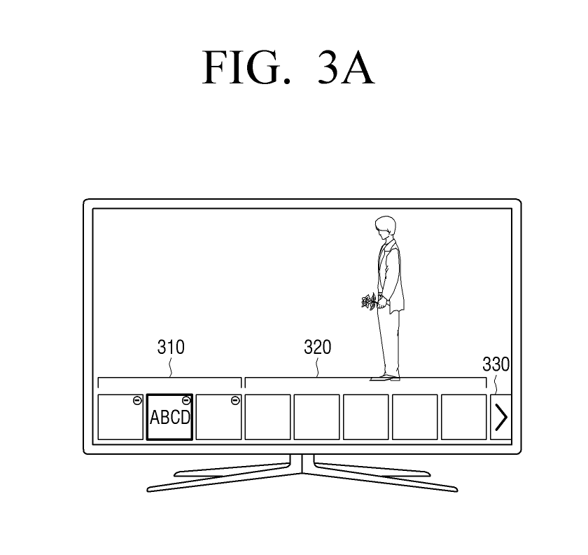

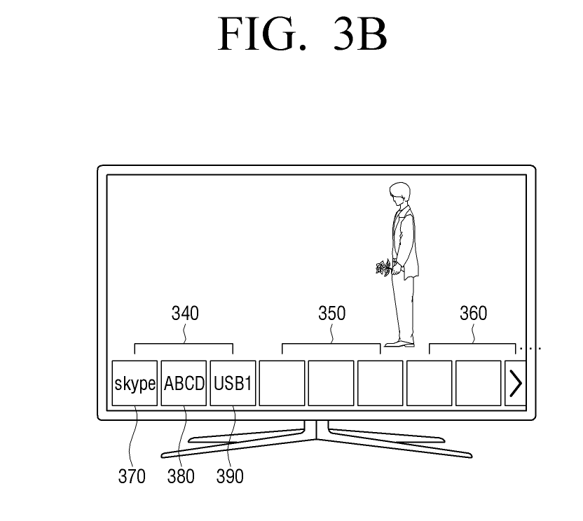

FIGS. 3A and 3B are drawings illustrating a UI screen which provides a GUI item in order according to various exemplary embodiments.

FIG. 3A is a view illustrating an icon 330 for confirming a favorite GUI item 310, a most used GUI item 320, and an additional GUI item, in a bottom of a screen according to an exemplary embodiment. In this example, the favorite GUI item 310 displays a GUI item corresponding to the first preference type, and the most used GUI item 320 displays a GUI item corresponding to the second preference type.

Each of the favorite GUI item 310 and the most used GUI item 320 may include a GUI item corresponding to, for example, an application, a channel, a function, and the like. Meanwhile, not only a channel but also a specific program provided by a broadcast service may be included.

A function may be an external input selection function, but it is not limited thereto, and may be a menu selection function, and the like.

The favorite GUI item 310 may be displayed with a GUI icon indicating content or a function designated by a user. The favorite GUI item 310 may add another mark to differentiate the favorite GUI item 310 from the most used GUI item 320. In FIG. 3A, a circle with hyphen ‘-’ therein is added in the upper right side, but this is just one of many possible examples. As another example, another character may be displayed or the brightness of the character may be adjusted higher or lower. Meanwhile, an example of a method of forming the favorite GUI item 310 by designating a content or a function by a user is explained below.

The most used GUI item 320 may include content or a function that a user most frequently uses. If the user watches a specific content, the display apparatus 100 may accumulate and store a use time of the specific content in the storage 120. For example, the specific content may be an application or a channel. Also, if a user uses a specific function, a frequency of use of the specific function may be accumulated and stored in the storage 120. The controller 130 may determine a content or a function to be displayed on the most used GUI item 320 based on a use time of the specific content and/or a frequency of use of the specific function, and determine an order thereof.

An icon 330 to confirm an additional GUI item may be displayed. As shown in FIG. 3A, the icon 330 may be displayed only on the right side, but may also be or instead be displayed on the left side, too. Whether to display the icon 330 for confirming an additional GUI item may be based on the number of GUI items indicating a predetermined user preference or preferred content and a user preference function. If the number of predetermined GUI items cannot entirely be displayed on the display 110 at once, the icon 330 for confirming an additional GUI item may be displayed. As another example, if the number of predetermined GUI items can be displayed on the display at once, the icon 330 for confirming an additional GUI item may not be displayed. Also, the number of predetermined GUI items can be changed by the user.

FIG. 3B is a drawing illustrating a method of displaying the most used GUI item 320 when a favorite GUI item 310 does not exist in a bottom of the screen, according to an exemplary embodiment.

FIG. 3B illustrates the most used GUI item only, but if a favorite GUI item is set, the favorite GUI item 310 may be displayed on the left side of the most used GUI item 320 as in the example of FIG. 3A.

Referring to FIG. 3B, the most used GUI item may group and alternatively display a GUI item corresponding to a preference application, a preference channel, and/or a preference function according to a type. For example, in a first group 340, Skype 370 may be grouped and displayed as a most preferable application by a user among applications, ABCD channel may be grouped and displayed as a most preferable channel by the user among channels, and USB1 390 may be grouped and displayed as a most preferable function among functions. According to a next preference, a GUI item corresponding to an application, a channel, and a function, respectively, may be displayed in a second group 350. A third group 360 may be displayed on the right side and may also include an item corresponding to an application, a channel, and a function. It should also be appreciated that FIG. 3B is merely for purposes of example, and a user may display a GUI item without grouping and also may indicate, group and alternatively display a part among an application, a channel and a function.

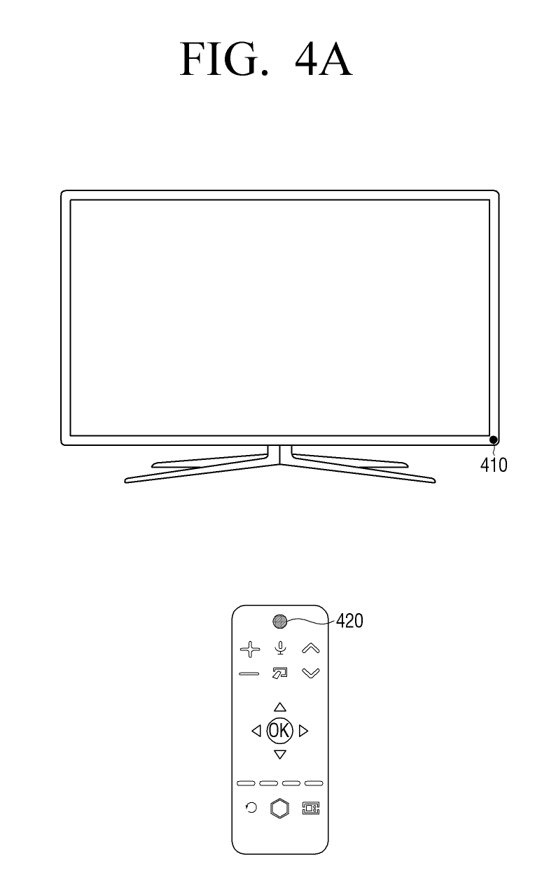

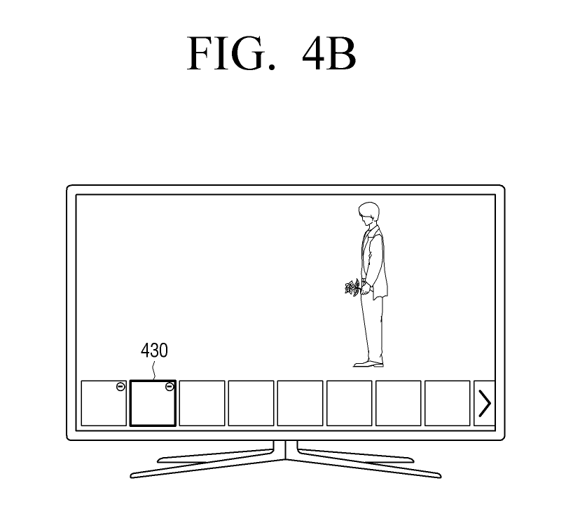

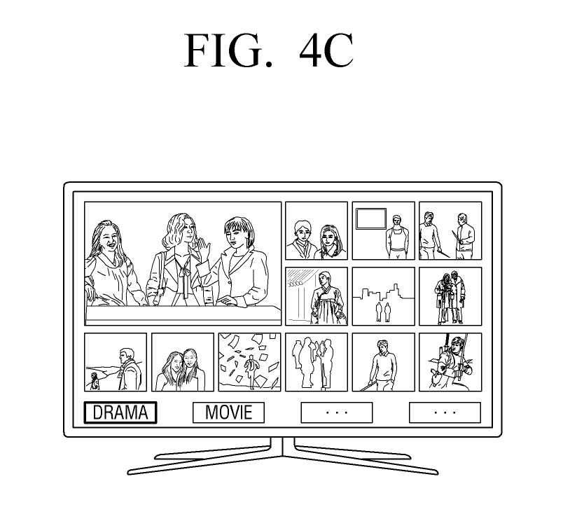

FIGS. 4A to 4C are drawings illustrating a UI screen which provides a GUI item according to various exemplary embodiments.

FIG. 4A is a drawing illustrating a method of entering a UI screen. In FIG. 4A, the display apparatus 100 includes a power button 410. If the display apparatus 100 is turned on by pushing the power button 410, the display apparatus 100 may provide a UI screen which includes a GUI item in order. At this time, content or a function which was displayed before the display apparatus 100 is turned off may be displayed again, and the UI screen which provides a GUI item in order may display a partial area of the display 110 to minimize an interruption for a user to watch. The same is also true when the display apparatus 100 is turned on by a remote controller shown in FIG. 4A.

While a specific content or a function is displayed, a user may display a UI screen by pushing a menu entry button 420 of a remote controller illustrated in FIG. 4A, and an example of this is explained in FIG. 4B.

Referring to FIG. 4B, a UI screen is displayed by pushing the menu entry button 420 of the remote controller, and the UI screen is displayed on a portion of the display 110. As illustrated above, it may be divided into the favorite GUI item 310 and the most used GUI item 320. Also, the user may provide a focus 430 or selection in order to select a specific GUI item. The focus may distinguish a GUI item which is focused on from among other GUI items, for example, by making an edge of a GUI item thicker, differentiating a brightness of a GUI item, and the like.

A GUI item corresponding to content may be in a shape of a thumbnail, and a GUI item corresponding to a function may be displayed in a shape of an icon, but this is just one of many examples, and it may be displayed in an opposite shape, and the like.

FIG. 4C is a drawing illustrating a UI screen provided if the menu entry button 420 of a remote controller is pushed again while the UI screen is displayed according to FIG. 4B. Unlike the UI screen which provides a GUI item in order in FIG. 4B, FIG. 4C is a drawing illustrating a detailed UI screen. In FIG. 4C, various kinds of drama information is displayed in a shape of a thumbnail in a state in which a drama tap is selected, and the drama information may be provided according to a time order, an order reflecting a user preference, and the like.

Not only a drama tap, but also a movie tap, a function tap, an application tap and the like may be provided, and it is also possible to add a specific tab according to a user's setting. Also, the information may be provided not only in a shape of a thumbnail, but also in a shape a video, and may be provided to each screen in a shape of a video. The user may set the number of contents to be provided in the screen as he/she wants.

In a state as shown in FIG. 4C, if a user pushes the menu entry button 420 of the remote controller, the screen may return to the UI screen as shown in the example of FIG. 4B, the UI screen may be removed, or the like. Such a decision may be set by the user.

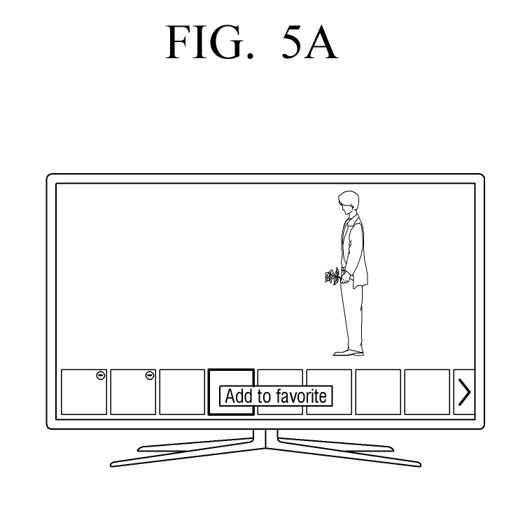

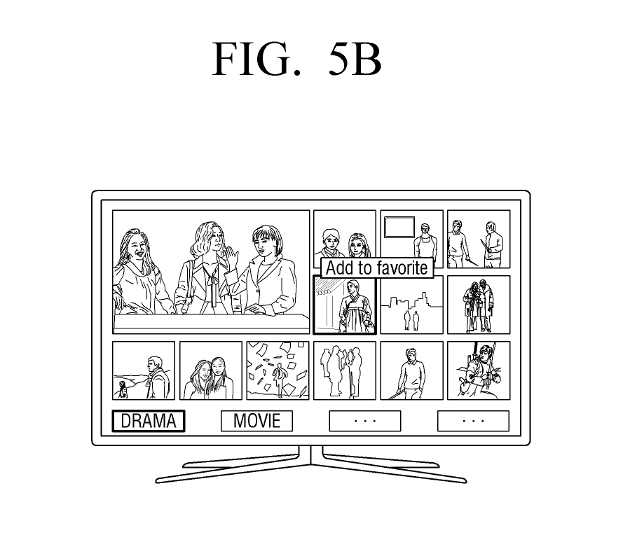

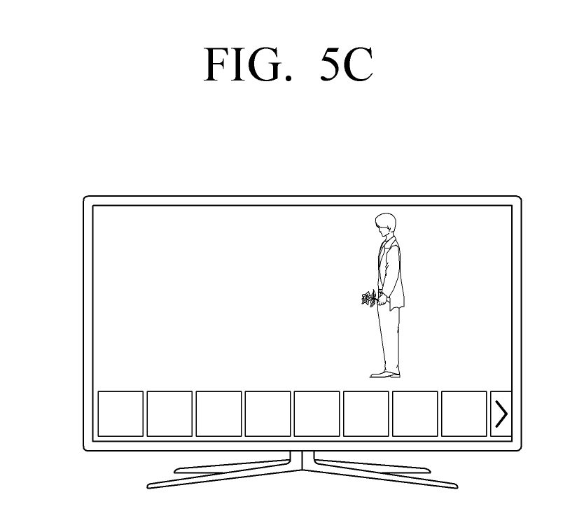

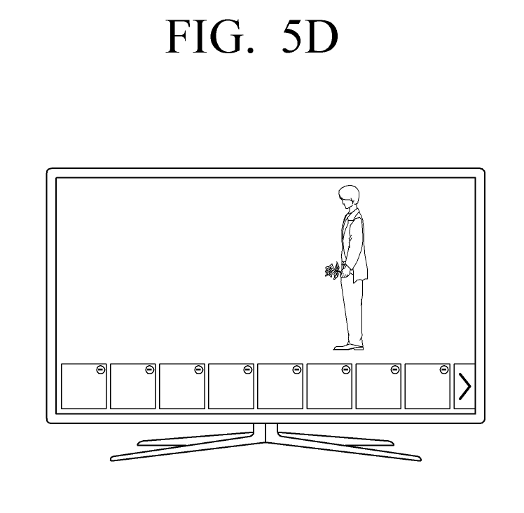

FIGS. 5A to 5D are drawings illustrating a favorite GUI item according to various exemplary embodiments.

FIG. 5A is a drawing illustrating a method of composing the favorite GUI item 310 on a UI screen which provides a GUI item in an order according to an exemplary embodiment. In FIG. 5A, two contents or functions are stored in the favorite GUI item such as GUI item 310 shown in FIG. 3A. At this time, the user may add a specific GUI item among GUI items displayed in the most used GUI item 320 as the favorite GUI item 310 for a user to more conveniently use the specific GUI item.

If a particular button is pushed while the focus is focused on a GUI item, an add to favorite menu may be displayed and a user may add the GUI item to the favorite GUI item 310 through an OK button of a remote controller. For example, the added GUI item may be located on the left most side of the favorite GUI item 310, but this is just one of many examples, and it may be located in alphabetical order, not the added time order, the order may be set by the user, and the like.

FIG. 5B is a drawing illustrating a method of composing the favorite GUI item on the UI screen which provides a GUI item according to various exemplary embodiments. In FIG. 5B, a user may add a focused GUI item to the favorite GUI item such as the favorite GUI item 310 using the same method as illustrated above. Referring to FIG. 5A, a GUI item which is located in the most used GUI item 320 because of its frequent use may be added to the favorite GUI item 310. However, in FIG. 5B, various GUI items may be added to the favorite GUI item 310, and thus, the convenience of user may be further improved.

FIG. 5C is a drawing illustrating the favorite GUI item according to an exemplary embodiment. FIG. 5C is a drawing illustrating a state in which no content or function is added to the favorite GUI item. That is, referring to FIG. 5C, the most used GUI item 320 shown in FIG. 3A is displayed only. In this example, the user may not be interested in composing the favorite GUI item 310.

FIG. 5D is a drawing illustrating the favorite GUI item according to another exemplary embodiment. Referring to FIG. 5D, a user actively forms the favorite GUI item 310, and all of the other GUI items displayed in the display apparatus 100 correspond to the favorite GUI item such as GUI item 310 shown in FIG. 3A. In this case, the user may compose the favorite GUI item which the user wants, and thus, the convenience of user may be improved.

The display apparatus 100 may limit the number of GUI items including the favorite GUI item 310 and the most used GUI item 320 to a predetermined number, and this limit may be changed by a user's setting. Also, a predetermined number may consist of GUI items of the favorite GUI item 310 entirely. However, in this example, even if the most used GUI item 320 is not displayed, the display apparatus 100 may continue to store a use time of a content and a frequency of use of a function in the storage 120. In this example, if a user deletes a part of a content or a function from the favorite GUI item 310, and the total number of GUI items of the favorite GUI items 310 is less than the predetermined number, the most used GUI item 320 may then be displayed based on information stored in the storage 120.

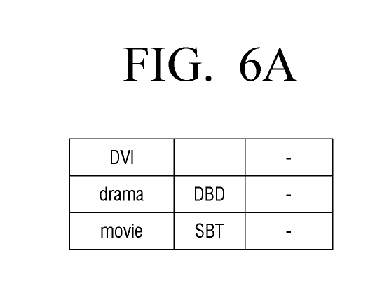

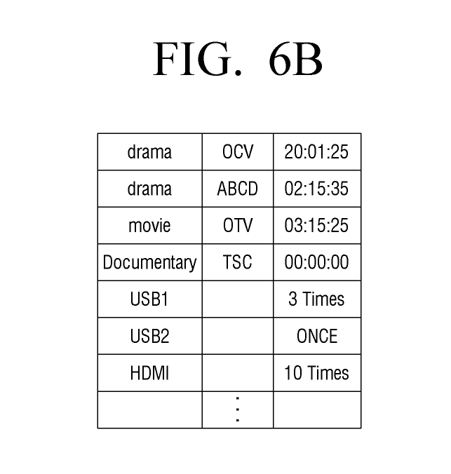

FIGS. 6A to 6B are drawings illustrating information stored in the storage 120 according to various exemplary embodiments. As a non-limiting example, the information may be stored in the form of tables.

FIG. 6A illustrates information corresponding to the first preference type. From the left side, a first column represents an upper category, and a second column represents the middle category. A third column represents a space in which a use time or a frequency of use is stored, and in this example it is a blank because there is no need to store the use time or the frequency of use when the type corresponds to the first preference type.

From the top, in this example, the first row represents a digital visual interactive (DVI) function, and the second row represents a DBD channel among drama channels. The third row represents a SBT channel among movie channels. Referring to FIG. 6A, the first preference type consists of a total of 3 channels, and this can be understood by the number of rows.

FIG. 6B illustrates information corresponding to the second preference type. In this example, information regarding the row and column is the same as described in FIG. 6A, and the third column is further explained. A use time of a content and a frequency of use of a function may be stored in the third column. For example, on the first row, a user watched the OCV channel among drama channels for total 20 hours 1 minute 25 seconds. Accordingly, the most used GUI item may be composed based on the viewing time. Even though it is not illustrated in FIG. 6B, a use time of an application is identical to the above explanation.

Referring to FIG. 6B, a USB1 function that is used 3 times is stored in a fifth row. In a case of a function, it is stored according to a frequency of use, and thus, it is different from a use time. For this, as an example, a manufacturing company may multiply a specific constant while manufacturing the display apparatus 100, and the like. For example, using a function once may be recognized as a use time of one hour. Also, a user may set these changes, and the frequency of use may be stored as the use time in the same manner as a content.

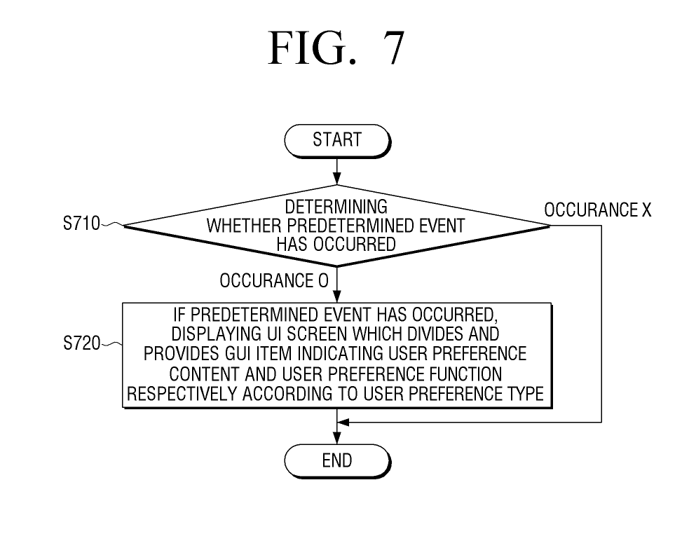

FIG. 7 is a flowchart illustrating a method of displaying a UI screen according to an exemplary embodiment.

Referring to FIG. 7, whether a predetermined event has occurred is determined in S710. If it is determined that the predetermined event has not occurred, no operation is performed.

If it is determined that the predetermined event has occurred, a UI screen which divides and provides a GUI item which indicates a user preference content and a user preference function, respectively, according to a user preference type, is displayed in S720. For example, the function may include an external input selection function.

The user preference content and a user preference function may be divided into the first preference type which is determined based on a user interaction and the second preference type which is determined based on a frequency of use.

Displaying a UI screen S720 may provide a GUI item corresponding to the first preference type in an order prior to a GUI item corresponding to the second preference type.

If there are a plurality of GUI items corresponding to the second preference type, a UI screen S720 may provide a GUI item in an order based on a use time of a user preference content and a frequency of use of a user preference function.

The user preference content may include a preference application and a preference channel. Displaying a UI screen S720 may group, alternatively display and provide a GUI item corresponding to a preference application, a preference channel and a preference function according to a type.

Displaying a UI screen S720 may provide a GUI item on a portion of a screen in a shape that is enumerated in a row direction according to the predetermined first event, and may categorize and provide a GUI item on an entire area of a screen according to a predetermined second event.

Displaying a UI screen S720 may display a GUI item indicating a user preference content in a shape of a thumbnail.

Displaying a UI screen S720 may further include receiving a user instruction, and may change a preference type of the second preference type item selected according to a user instruction predetermined on the UI screen, to the first preference type.

Displaying a UI screen S720 may display identification information which indicates the first preference type on a GUI item indicating a user preference content and a user preference function of the first preference type.

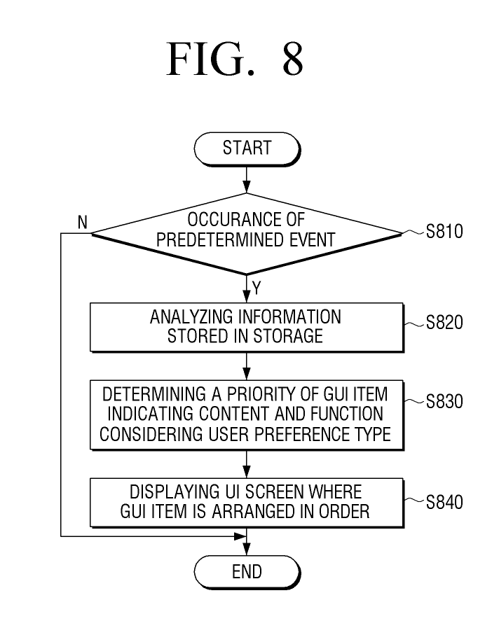

FIG. 8 is a flowchart illustrating a method of displaying a UI screen according to another exemplary embodiment.

Referring to FIG. 8, whether a predetermined event has occurred by a user in S810. If a predetermined event has not occurred, the method of the display apparatus 100 does not perform another step. For example, the predetermined event may be turning on the display apparatus 100 using the power button 410, turning on the display apparatus 100 using a remote controller, pushing the menu entry button 420 of the remote controller, and the like.

If an event predetermined by a user has occurred, the display apparatus 100 analyzes information stored in the storage 120 in S820. A UI screen which provides a GUI item provided from the display 100 in an order and provides information regarding a user preference content and a user preference function divided according to a user preference type may be stored in the storage 120.

The display apparatus 100 determines a priority of a GUI item indicating a content and a function considering a user preference type and the like in S830. For example, a priority from among the first preference type and the second preference type may be determined.

If a priority is determined, a UI screen in which a GUI item is arranged in order is displayed in S840. For example, the GUI item may be displayed in a shape of a thumbnail, and a setting regarding the number of GUI items displayed in the display 110 may be changed by a user.

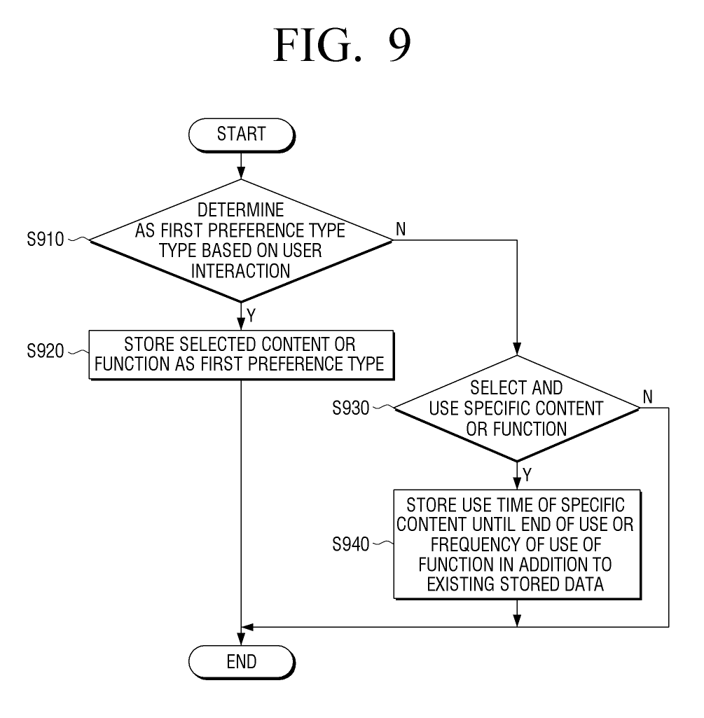

FIG. 9 is a flowchart illustrating data stored in the storage 120 according to an exemplary embodiment.

Referring to FIG. 9, content or a function is determined as the first preference type based on a user interaction S910. The first preference type may be determined through a UI screen which provides a GUI item in an order or a UI screen which provides a GUI item on an entire area of the screen.

A user may determine or select, and use, specific content or a function as the first type from a UI screen which provides a GUI item in an order, or from a UI screen which provides a GUI item on an entire area of the screen. If the user determines a specific content or a function as the first preference type in S910, the display apparatus 100 stores the selected content or the function as the first preference type in S920.

If a user selects and uses a specific content or a function in S930, a use time of a specific content or a frequency of use of a function is stored in addition to an existing stored data in S940. Then, the display apparatus 100 determines a priority of a GUI item based on data stored accumulatively.

According to one or more exemplary embodiments, the display apparatus 100 provides various contents and functions more efficiently through a UI screen, and thus, the convenience of user may be enhanced.

Methods according to one or more various exemplary embodiments may be programmed and stored in various non-transitory storage mediums. Accordingly, the methods according to various embodiments described above may be realized in various types of electronic apparatuses which execute a storage medium.

To be specific, according to an exemplary embodiment, a non-transitory computer readable medium where a program which performs determining whether a predetermined event has occurred and if the predetermined event has occurred, displaying a UI screen which divides and provides a GUI item indicating a user preference content and a user preference function, respectively according to a user preference type, is stored, may be provided.

The non-transitory readable medium may include a medium which stores a data permanently or semi-permanently and is readable by an apparatus, not a media which stores a data for a short period such as a register, a cache, a memory and so on. For example, a CD, a DVD, a hard disk, a Blu-ray disk, a USB, a memory card and ROM may be the non-transitory readable medium

Various exemplary embodiments are illustrated in the drawings and explained herein, but the inventive concept is not limited to the described exemplary embodiments. Also, the description of one or more of the exemplary embodiments is intended to be illustrative, and not to limit the scope of the claims, and it should be appreciated by those skilled in the art that changes may be made to one or more of the exemplary embodiments without departing from the principles and spirit of the inventive concept, the scope of which is defined in the appended claims.

What is claimed is:

1. A display apparatus comprising:
a display configured to display a user interface (UI) screen;
a storage configured to divide and store information about a user preference content and a user preference function according to a user preference type; and
a controller configured to, in response to a predetermined event, control the display to display a UI comprising the graphic user interface (GUI) item indicating a user preference content and a GUI item indicating the user preference function, respectively, based on the information stored in the storage.

2. The display apparatus as claimed in claim 1, wherein the user preference content and the user preference function are divided into a first preference type which is determined based on a user interaction and a second preference type which is determined based on a frequency of use.

3. The display apparatus as claimed in claim 2, wherein the controller is configured to provide a GUI item corresponding to the first preference type prior to a GUI item corresponding to the second preference type, in order.

4. The display apparatus as claimed in claim 2, wherein the controller is configured to, in response to there being a plurality of GUI items corresponding to the second preference type, provide the plurality of GUI items in order based on a use time of the user preference content and a frequency of use of the user preference function.

5. The display apparatus as claimed in claim 1, wherein the user preference content comprises a preference application and a preference channel, and
the controller is configured to group a GUI item corresponding to the preference application, the preference channel and the preference function according to a preference type, and alternatively display and provide the grouped GUI items.

6. The display apparatus as claimed in claim 1, wherein the controller is configured to provide the GUI item in a shape that is enumerated in a row on a partial area of a screen according to a predetermined first event, and categorize and provide the GUI item on an entire area of the screen according to a predetermined second event.

7. The display apparatus as claimed in claim 1, wherein the controller is configured to control the display to display the GUI item which indicates the user preference content in a shape of a thumbnail.

8. The display apparatus as claimed in claim 1, wherein the user preference function comprises an external input selection function.

9. The display apparatus as claimed in claim 2, further comprising:
a user interface configured to receive a user instruction,
wherein the controller is configured to convert a second preference type item selected on the UI screen to the first preference type, in response to a predetermined user instruction being received.

10. The display apparatus as claimed in claim 2, wherein the controller is configured to display identification information which indicates the first preference type on a GUI item indicating a user preference content and a user preference function of the first preference type.

11. A method of controlling a display apparatus, the method comprising:
determining whether a predetermined event has occurred; and
in response to determining that the predetermined event has occurred, displaying a user interface (UI) screen which divides and provides a graphic user interface (GUI) item indicating a user preference content and a GUI item indicating a user preference function, respectively, according to a user preference type.

12. The method as claimed in claim 11, wherein the user preference content and the user preference function are divided into a first preference type determined based on a user interaction and a second preference type determined based on a frequency of use.

13. The method as claimed in claim 12, wherein the displaying the UI screen comprises providing a GUI item corresponding to the first preference type prior to a GUI item corresponding to the second preference type, in order.

14. The method as claimed in claim 12, wherein the displaying the UI screen comprises providing the GUI item in order based on a use time of the user preference content and a frequency of use of the user preference function, in response to there being a plurality of GUI items corresponding to the second preference type.

15. The method as claimed in claim 11, wherein the user preference content comprises a preference application and a preference channel, and
the displaying the UI screen comprises grouping a GUI item corresponding to the preference application, the preference channel, and the preference function, and alternatively displaying and providing the grouped GUI items.

16. The method as claimed in claim 11, wherein the displaying the UI screen comprises providing the GUI item in a shape that is enumerated in a row on a partial area of a screen according to a predetermined first event, and categorizing and providing the GUI item on an entire area of a screen according to a predetermined second event.

17. A display apparatus comprising:
a storage configured to store information about content that is selected as a favorite of a user, and to store information about content that is most used by the user; and
a controller configured to control a display to output a user interface (UI) screen simultaneously displaying at least one graphical user interface (GUI) item corresponding to the content that is selected as the favorite of the user and at least one GUI item corresponding to the content that is the most used by the user.

18. The display apparatus of claim 17, wherein the controller is further configured to visually differentiate the at least one GUI item corresponding to the content that is selected as the favorite of the user and the at least one GUI item corresponding to the content that is most used by the user.

19. The display apparatus of claim 17, wherein the controller is configured to display a GUI item for each of a function and a channel for each of the content that is selected as the favorite of the user and the content that is most used by the user.

20. The display apparatus of claim 17, wherein the UI screen comprises a scrollable list of GUI items located on only a portion of the display.
